(19) United States
(12) Patent Application Publication
(10) Pub. No.: US 2011/0009016 A1
(43) Pub. Date: Jan. 13, 2011

(54) SNAP HOUSING FOR A MODULAR CONNECTOR ASSEMBLY

(76) Inventors: Sam Liu, Sunnyvale, CA (US); Aurielo Hernandez, Hollister, CA (US)

Correspondence Address: SCHEIN & CAI LLP;James Cai, 111 W. ST. JOHN ST., SUITE 1250, SAN JOSE, CA, 95113, US

(21) Appl. No.: 12/498,695

(22) Filed: Jul. 7, 2009

(51) Int. Cl. H01R 13/46

(52) U.S. Cl. 439/892

(57) ABSTRACT

The present invention is directed to a snap housing for a modular connector assembly that includes a first body having first and second opposed surfaces, the second surface has a first profile, a portion of which is complementary to a profile of a first segment of the modular connector assembly; a second body having third and fourth opposed surfaces, the fourth surface having a second profile, a portion of which is complementary to a segment of a profile of a second segment of the modular connector assembly. The second surface faces the fourth surface; and a pair of spaced-apart fasteners is disposed between the first and second bodies to rotate or move horizontally with respect to the first and second bodies.

### BACKGROUND OF THE INVENTION

The present invention generally relates to electrical connectors such as modular connector assemblies.

A modular connector assembly is a class of connector assembly that was traditionally used in the telecommunications industry and has found expanded use in other signal transmission systems, such as personal and mainframe computers. A modular connector assembly is characterized by employing a compact foot print and simple retaining mechanism that facilitates securely fastening the connector assembly to a receptacle. This usually includes a resilient member fabricated from plastic or some other resilient material that forms an interference fit with the bulwark that surrounds the receptacle. Use of the resilient member eases the effort required to decouple the modular connector assembly from the receptacle. A disadvantage with the resilient member is that the structural integrity of the same becomes compromised due to use resulting in the same segmenting from the modular connector assembly. In this situation, the positional stability of the modular connector assembly in the receptacle is not secure. This may prove problematic.

Jacks associated with modular connector assemblies have positions and contacts, with a position being a location for one of the contacts. A contact exists when a wire or some other conductor is present in the position. Typical sizes for jacks are 4P4C, 6P6C, 8P8C and 10P10C. “P” refers to positions, and “C” refers to contacts. It should be borne in mind that modular connector assemblies exist in which contacts are not present in each position.

Probably the most well known application of a modular connector is for telephone and Ethernet receptacles. As a result, the prior art is replete with various designs for modular connector assemblies.

U.S. Pat. No. 6,589,076 to Davis et al. discloses an electrical connector having an inner dielectric housing adapted for mounting a plurality of electrical contacts and including at least one forwardly projecting mating portion having opposite sides. The connector has a metallic shield surrounding a major portion of the inner dielectric housing. An outer dielectric cover has a front, a back, a top, a bottom, a first side, and a second side opposite the first side. The outer dielectric cover surrounds a major portion of the metallic shield and includes first and second integrally formed spring latches. The first integrally formed spring latch extends forwardly from the back along the top, and the second integrally formed spring latch extends forwardly from the back along the bottom. The first and second spring latches each comprise a spring portion and a distal grip, with the distal grips being constructed and arranged to compress the spring latches when a user urges them inwardly toward each other to install the connector in a computer case. When the user releases the grip, the connector is securely held in the computer case by spring biasing provided by the spring latches until a user compresses the spring latch to quickly release the connector from the computer.

U.S. Pat. No. 6,343,948 to Nutzel discloses a plug connector having a plug and a mating connector, of which one has latching arms, which during the coupling operation, interact with corresponding latching tabs on the other in order to lock the plug connection. The latching arms have, on their inner side at their free ends, a hook with a chamfered front side and a likewise chamfered rear side. As viewed in the plug-in direction, the latching tabs likewise have chamfered front and rear sides, with essentially identical angles of inclination in such a way that when latched the respective rear sides of the latching arms and latching tabs lie completely on top of one another, and on their outer sides, between their end connected to the housing and the point at which they rest on the latching tab. The latching arms can be pressed in resiliently until the rear side of their respective latching hook pivots around the ridge of the latching tab, runs essentially parallel to the plug-in direction and enables the connection to be released.

U.S. Pat. No. 6,305,986 discloses a cable connector assembly having a pair of USB connectors, a cable end electrically connecting to the pair of USB connectors, a pair of conductive latches positioned beside the USB connectors, a cover enclosing the USB connectors and a grounding bar positioned on an outer surface of the cover. Each latch is V-shaped and has a first arm electrically engaging with a conductive shell of the corresponding USB connector and a second arm extending out from the cover to electrically and mechanically engage with a grounding panel of an electronic apparatus with which the cable connector mates. The grounding bar has a base portion located on the cover and a pair of conductive tabs extending from the base portion into the cover and electrically engaging with the conductive shells of the pair of USB connectors. When the cable connector mates with the electronic apparatus, the pair of latches and the grounding bar electrically engage with the grounding panel of the electronic apparatus and connect the conductive shells of the USB connectors to a reference grounding potential.

Therefore, a need exists to provide improved functionality to modular connector assemblies.

### BRIEF SUMMARY OF THE INVENTION

The present invention is directed to a snap housing for a modular connector assembly that includes a first body having first and second opposed surfaces, the second surface has a first profile, a portion of which is complementary to a profile of a first segment of the modular connector assembly; a second body having third and fourth opposed surfaces, the fourth surface having a second profile, a portion of which is complementary to a segment of a profile of a second segment of the modular connector assembly. The second surface faces the fourth surface; and a pair of spaced-apart fasteners is disposed between the first and second bodies to rotate with respect to the first and second bodies. The second and fourth surfaces are featured and face one another, defining first, second and third volumes. The second volume includes opposed openings and has a shape, a portion of which, is complementary to a shape of a segment of a modular connector assembly. The first and second volumes are disposed on opposite sides of the second volume. Industrial standard thumbscrews are rotatably disposed in each of first and second volumes. The first body includes a protrusion and the second body includes a flexible tab having an orifice, with protrusion being received within the orifice, forming an interference fit with the tab to fix a spatial relationship between the first and second bodies. These and other embodiments are discussed further below.

### BRIEF DESCRIPTION OF THE DRAWINGS

FIG. 1 is a perspective view of a snap housing including a modular connector assembly disposed therein in accordance with one embodiment of the present invention;

FIG. 2 is an exploded perspective view of the snap housing shown in FIG. 1;

FIG. 3 is a perspective view of the snap housing shown in FIG. 2 with first and second bodies being fixed in a final seating position;

FIG. 4 is a perspective of a body of the snap housing shown in FIGS. 1-3;

FIG. 5 is a cross-sectional view of the snap housing and modular connector assembly shown in FIG. 1 taken along lines 5-5;

FIG. 6 is a perspective view of the body shown in FIG. 4 in accordance with a second embodiment of the present invention;

FIG. 7 is a perspective view of a snap housing including a modular connector assembly disposed therein in accordance with a third embodiment of the present invention;

FIG. 8 is an exploded perspective view of a snap housing in accordance with the third embodiment of the present invention;

FIG. 9 is a cross-sectional view of the snap housing and modular connector assembly shown in FIG. 7 taken along lines 9-9; and

FIG. 10 is a perspective view of a fourth embodiment of the present invention.

### DETAILED DESCRIPTION OF THE INVENTION

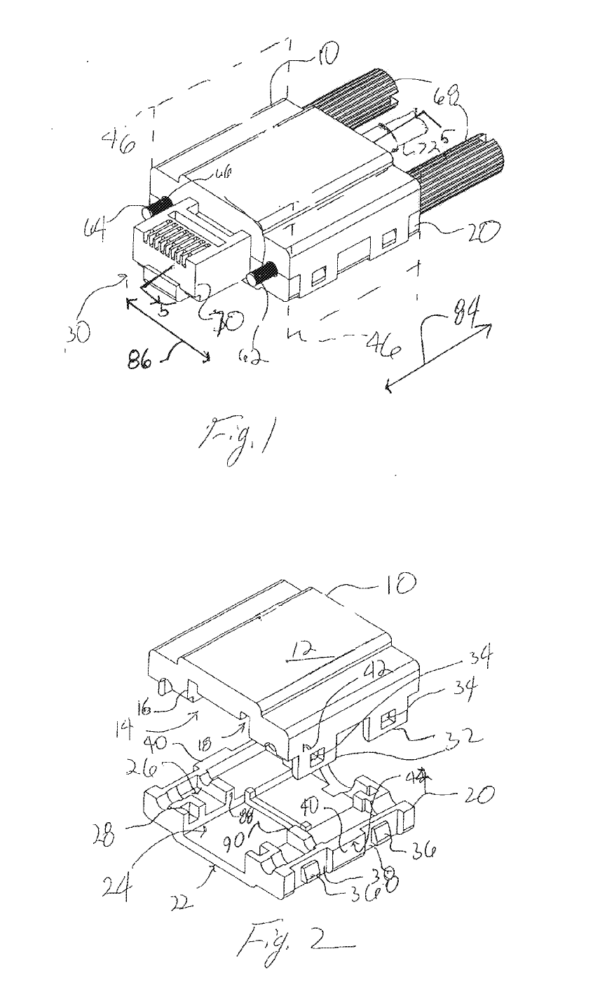

Referring to both FIGS. 1 and 2, a snap housing includes a first body 10 having first 12 and second 14 opposed surfaces. The second surface 14 is featured in that it includes a plurality of recesses and shoulders, shown generally as 16 and 18, respectively. A second body 20 has third 22 and fourth 24 opposed surfaces. The fourth surface 24 is featured in that it includes recesses and shoulders, shown generally as 26 and 28, respectively. The features of second 14 and fourth 24 surfaces are established so that a portion thereof are complimentary to the shape of a segment of a modular connector assembly 30 that is disposed therein. To securely affix together first 10 and second 20 bodies, first body 10 includes a plurality of tabs 32 each of which includes an orifice 34. Second body 20 includes a plurality of protrusions 36, each of which is received within the orifice 34 of one of the plurality of tab 32, upon first 10 and second 20 bodies reaching a final seating position.

Second 14 and fourth 24 surfaces are coextensive, and second body 20 includes multiple recesses 38, each of which surround a protrusion 36. Adjacent recesses 38 are separated by a detent 40. The relative dimensions of tabs 32 and recesses 38 are established so that a surface 42 of tabs 32 and a surface 44 of detent 40 are substantially coplanar upon first 10 and second 20 bodies reaching the final seating position. In this manner, surfaces 42 and 44 lie in a plane 46 that extends transversely to first 12, second 14, third 22 and fourth 24 surfaces.

Referring to FIGS. 1, 2 and 3, in the final seating position, the second 14 and fourth 24 surfaces define first 48, second 50 and third 52 volumes. First 48 and third 52 volumes are disposed on opposite sides of second volume 50. Second volume 50 has a shape, a portion of which is complementary to a shape of a segment of a modular connector assembly 30 that is contained therein. Opposed openings 54 and 56 are disposed at opposite ends of the second volume 50. Opposed opening 54 has a width 58 greater than a height 60, with width 58 extending parallel to both first 12 and third 22 surfaces. A pair of spaced-apart fasteners 62 and 64 is disposed between the first 10 and second 20 bodies. Specifically, fastener 64 is disposed to rotate within the first volume 48, and fastener 62 is disposed to rotate within the third volume 52. Although any type of fastener may be employed, such as industrial standard fasteners, in the present example fasteners 62 and 64 are M2 thumbscrews, with a threaded portion 66 and a knurled portion 68. Fastener 64 extends from volume 48 proximate to one terminus of width 58, with fastener 64 extending from volume 52 proximate to an opposing terminus of width 58. In this manner, opposed openings 54 and 56 are disposed between fasteners 62 and 64.

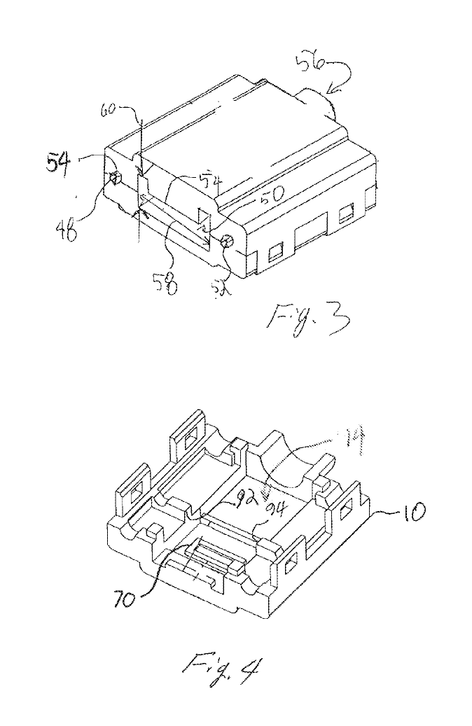

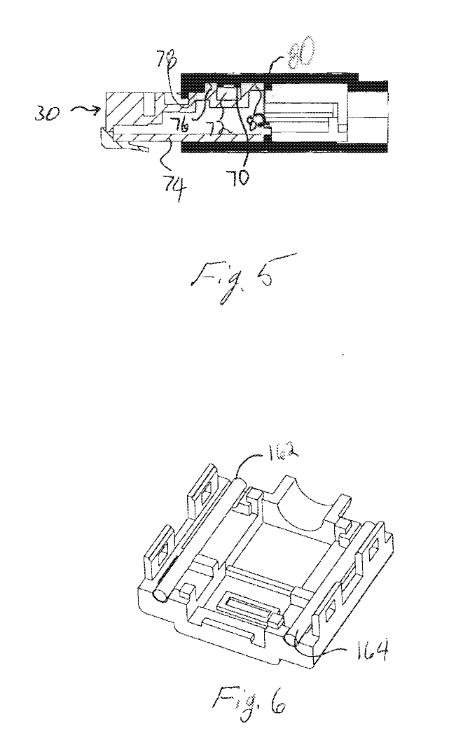

Referring to FIGS. 3, 4 and 5, as mentioned above, second volume 50 has a shape that is substantially complementary to a portion of modular connector a ssembly 30 that will be disposed therein. For example, a rectangular protrusion 70 extends from second surface 14 a sufficient distance so as to be received within a recess 72 of a body 74 of modular connector assembly 30. A distance between rectangular protrusion 70 and an adjacent shoulder 76 is sufficient to fixedly retain a portion 78 of body 74 therebetween. Similarly, a distance between rectangular protrusion 70 and a shoulder 80 is established to fixedly retain a portion of body 74 there between. In this manner, movement of modular connector assembly 30 and first and second bodies 10 and 20 along direction 84 is maintained, shown in FIG. 1.

Referring to FIGS. 1, 2, 4 and 5, in a similar fashion, movement between modular connector assembly 30 and first and second bodies 10 and 20 along a direction 86 transverse to direction 84. For example, body 74 is received between opposed shoulders 88 and 90 of surface 24, shown in FIG. 2, and shoulders 92 and 94 of surface 144. First 10 and second 20 bodies may be used with virtually any modular connector assembly. In the present example the modular connector assembly 30 includes an 8P8C jack 70 and wire configuration 72 coupled to the jack that extends through volume 50 and out opening 56.

Referring to both FIGS. 1 and 6 in accordance with an alternate embodiment, fasteners 162 and 164 are magnets. This facilitates use of the invention in the absence of threaded holes to receive fasteners 62 and 64, shown in FIG. 1. Rather, all that is needed to support coupling of modular connector assembly 30 using a secondary fastener is magnetically responsive material proximate to modular connector assembly 30.

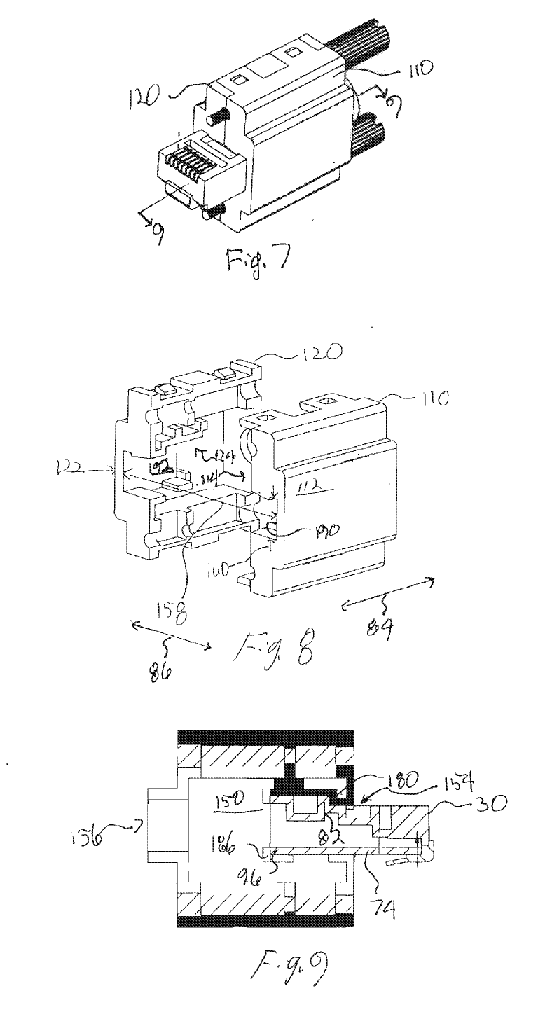

Referring to FIGS. 1 and 7, in accordance with another embodiment, first body 110 and second body 120 are substantially identical to bodies 10 and 20, excepting featured second surface 114 and featured fourth surface 124, shown in FIG. 8.

Referring to both FIGS. 1, 8 and 9 featured second 112 and fourth 124 surfaces define a volume 150 that is rotated 90° with respect to the orientation of volume 50, discussed above with respect to FIG. 3.

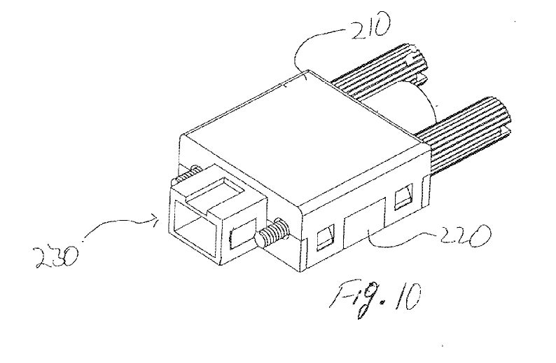

Referring to both FIGS. 8 and 9, one of opposed openings 154 and 156, which are disposed at opposite ends of the second volume 150, has a width 158 greater than a height 160, with width 158 extending transversely to both first 112 and third 122 surfaces. Additionally, the position of modular connector assembly 30 with respect to bodies 110 and 120 is fixed along direction 84 by shoulder 180 resting against portion 82 of body 74 and shoulder 186 resting against portion 96 of body 74. Region 190 of second surface 114 and region 192 of fourth surface 124 maintain the positional relationship between modular connector assembly 30 and first and second bodies 110 and 120 along direction 86.

Referring to FIG. 10 an example of another modular connector assembly that may be employed includes a jack 230 that is configured as an IEEE 1394 interface. To that end, first 210 and second 220 bodies include second and fourth surfaces (not shown) that are featured to define a volume (not shown) a portion of which, has a shape complementary to a segment of the shape of modular connector assembly 230 disposed therein.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. For examples, numerous other modular connector assemblies may be employed in lieu of the modular connector assemblies set forth above. For example, modular connector assemblies employing MPNC jacks may be employed where M is a number between 1 and 10 and N is a number between 1 and 10. Alternatively, modular connector assemblies employing RJ-XX jacks, DE-9 jack, HDMI, FireWire, USB jacks, RCA jack and the like may also be employed. Therefore, the scope of the appended claims should be accorded the broadest interpretation so as to encompass all such modifications and similar arrangements.

1. A snap housing for a modular connector assembly, said housing comprising:
a first body having first and second opposed surfaces, said second surface having a first profile, a portion of which, matching a profile of a first segment of said modular connector assembly;
a second body having third and fourth opposed surfaces, said fourth surface having a second profile, a portion of which, matching a profile of a second segment of said modular connector assembly, with said second surface facing said fourth surface; and
a pair of spaced apart fasteners disposed between said first and second bodies to rotate with respect to said first and second bodies.

2. The housing as recited in claim 1 wherein a part of said spaced-apart openings is defined by placement of said first body in superimposition with said second body, one of said of spaced-apart openings having a width greater than a height, with said pair of spaced-apart fasteners being disposed proximate to opposing terminuses of said height.

3. The housing as recited in claim 1 wherein a pair of spaced-apart-openings is defined by placement of said first body in superimposition with said second body, one of said spaced-apart openings having a height greater than a width, with said pair of spaced-apart fasteners being disposed proximate to opposing terminuses of said height.

4. The housing as recited in claim 1 wherein said fasteners are selected from a set of fasteners consisting of essentially thumbscrews and magnets.

5. The housing as recited in claim 1, wherein said first body includes a protrusion and said second body includes a flexible tab having an orifice, with said protrusion forming an interference being received within said orifice, forming an interference fit with said tab to fix a spatial relationship between said first and second bodies.

6. The housing as recited in claim 1, wherein a pair of spaced-apart openings are defined by placement of said first body in superimposition with said second body, said pair of spaced-apart openings being disposed between said fasteners.

7. The housing as recited in claim 1, wherein a pair of spaced-apart openings are defined by placement of said first body in superimposition with said second body, with one of said openings having a shape matching a profile of a jack selected from a set of jacks consisting essentially of MPNC where M is a number between 1 and 10 and N is a number between 1 and 10.

8. The housing as recited in claim 1, wherein a pair of spaced-apart openings are defined by placement of said first body in superimposition with said second body, with one of said openings having a shape matching a profile of a jack selected from a set of jacks consisting essentially of RJ-XX, HDMI, and FireWire, DE-9, USB and RCA.

9. A snap housing for a modular connector assembly, said housing comprising:
a first body having first and second opposed surfaces, said second surface being featured;
a second body having third and fourth opposed surfaces, said fourth surface being featured, with said second surface facing said fourth surface defining a volume having a shape, a portion of which is complementary in shape of a segment of said modular connector assembly; and
a pair of fasteners extending parallel to said volume, with said opposed openings being disposed between said pair of fasteners.

10. The housing as recited in claim 9 wherein said second and fourth surfaces define two additional volumes, disposed on opposing sides of said volume, with one of said pair of fasteners being disposed within one of said two additional volumes.

11. The housing as recited in claim 9 wherein said fasteners are selected from the set of fasteners consisting of essentially thumbscrews and magnets.

12. The housing as recited in claim 8 wherein said body includes a protrusion and said second body includes a flexible tab having an orifice, with protrusion forming an interference being received within said orifice, forming an interference fit with said tab to fix a spatial relationship between said first and second bodies.

13. The housing as recited in claim 9 wherein one of said of spaced apart openings having a width greater than a height, with said pair of spaced-apart fasteners being disposed proximate to opposing terminuses of said height.

14. The housing as recited in claim 9 wherein one of said spaced-apart openings having a height greater than a width, with said pair of spaced-apart fasteners being disposed proximate to opposing terminuses of said height.

15. The housing as recited in claim 9 wherein one of said openings having a shape matching a profile of a jack selected from a set of jacks consisting essentially of RJ-XX, HDMI, FireWire, DE-9, USB and RCA.

16. A snap housing for a modular connector assembly, said housing comprising:
a first body having first and second opposed surfaces, said second surface being featured;
a second body having third and fourth opposed surfaces, said fourth surface being featured, with said second surface facing said fourth surface defining first, second and third volumes, with said second volume having opposed openings and a shape, a portion of which is complementary to a shape of a segment of said modular connector assembly, with said first and second volumes being disposed on opposite sides of said second volume; and
a pair of industrial standard thumbscrews each of which is rotatably disposed with one of said first and second volumes.

17. The housing as recited in claim 16 wherein said first body includes a protrusion and said second body includes a flexible tab having an orifice, with protrusion forming an interference being received within said orifice, forming an interference fit with said tab to fix a spatial relationship between said first and second bodies.

18. The housing as recited in claim 16 wherein one of said spaced apart openings having a width greater than a height, with said pair of spaced apart fasteners being disposed proximate to opposing terminuses of said height.

19. The housing as recited in claim 16 wherein one of said spaced-apart openings having a height greater than a width with said pair of spaced-apart fasteners being disposed proximate to opposing terminuses of said height.

20. The housing as recited in claim 16, wherein one of said openings having a shape matching a profile of a jack selected from a set of jacks consisting essentially of RJ-XX, HDMI, FireWire, DE-9, USB and RCA.
